(19) United States
(12) Patent Application Publication
(10) Pub. No.: US 2011/0052077 A1
(43) Pub. Date: Mar. 3, 2011

(54) RESOLUTION INCREASING APPARATUS AND RESOLUTION INCREASING METHOD

(75) Inventor: Nau Ozaki, Tokyo (JP)

(73) Assignee: KABUSHIKI KAISHA TOSHIBA, Tokyo (JP)

(21) Appl. No.: 12/726,478

(22) Filed: Mar. 18, 2010

(30) Foreign Application Priority Data
Aug. 28, 2009 (JP) 2009-198736

(51) Int. Cl. G06K 9/36; G06K 9/46

(52) U.S. Cl. 382/195; 382/232

(57) ABSTRACT

A resolution increasing apparatus includes: a candidate specifying section configured to sequentially set pixels of notable points one by one from multiple pixels in one image; a matching error calculating section and the like configured to extract a corresponding point B corresponding to a pixel of a notable point A from a corresponding block Q having a pixel value change pattern identical or similar to a pixel value change pattern included in a notable block P that includes the pixel of the notable point A; a corresponding point increasing section configured to generate a new corresponding point C within an interval of a line segment obtained by rectilinearly connecting the notable point A and the corresponding point B; and a high-resolution pixel value calculating section configured to calculate a pixel value of a high-resolution image from the notable point A, the corresponding point B and the new corresponding point C.

### CROSS-REFERENCE TO RELATED APPLICATIONS

This application is based upon and claims the benefit of priority from the prior Japanese Patent Application No. 2009-198736 filed in Japan on Aug. 28, 2009; the entire contents of which are incorporated herein by reference.

### BACKGROUND OF THE INVENTION

1. Field of the Invention

The present invention relates to a resolution increasing apparatus configured to convert image data, such as video received by a TV set and a still image or motion picture taken by a camera, to image data with a higher resolution and a resolution increasing method.

2. Description of the Related Art

Recently, displays with a large number of pixels, that is, high-resolution displays for TV sets, mobile phones and the like have been widely spread. When an image is displayed on a TV set or a display, image data with a low resolution, that is, image data with a small number of pixels is converted to image data with the number of pixels of the high-resolution panel. Especially, as a method for obtaining a clearer image than a linear interpolation method in resolution increasing conversion for increasing the number of pixels, there is, for example, an intra-frame deterioration inverse conversion method as disclosed in Japanese Patent Application Laid-Open Publication No. 2007-310837.

The intra-frame deterioration inverse transformation method is a method which pays attention to the fact that, when a part of an image frame including a subject is taken out to check a brightness value change pattern in the part, the same pattern exists near the part. In the method, multiple corresponding blocks having the same brightness value change pattern as a notable block are detected in a reference frame, and the position of a corresponding point of each corresponding block in the reference frame is calculated. Then, a high-resolution image is obtained by calculating pixel values of sample points in the high-resolution image from the calculated multiple corresponding points.

According to the method described above, a high-resolution image can be obtained from a low-resolution image. However, when an error between a notable block and a corresponding block is calculated, the position of a block having pixel values close to those of the notable block is determined on the basis of non-integer pixel precision, and, therefore, calculation for determining the sum of absolute differences, the sum of squared differences and the like between the two blocks is performed. A great amount of calculation is required for such calculation.

In the method described above, more corresponding points are required to determine a more accurate resolution image. However, as the number of corresponding points to be calculated is increased, calculation such as for the sum of squared differences is performed the number of times corresponding to the increased number of corresponding points. Therefore, there is a problem that the amount of calculation accumulatively increases as the number of corresponding points increases.

### BRIEF SUMMARY OF THE INVENTION

According to an aspect of the present invention, it is possible to provide a resolution increasing apparatus including: a notable pixel setting section configured to sequentially set pixels of notable points one by one from multiple pixels in one image; a corresponding point extracting section configured to extract a corresponding point corresponding to a pixel of the notable point from a corresponding block having a pixel value change pattern identical or similar to a pixel value change pattern included in a notable block that includes the pixel of the notable point; a new corresponding point generating section configured to generate a new corresponding point within an interval of a line segment obtained by rectilinearly connecting the notable point and the corresponding point; and a high-resolution pixel value calculating section configured to calculate a pixel value of a high-resolution image from the notable point, the corresponding point and the new corresponding point.

### BRIEF DESCRIPTION OF THE DRAWINGS

FIG. 1 is a configuration diagram showing a configuration of an image processing apparatus 1 according to a first embodiment of the present invention;

FIG. 2 is a flowchart for illustrating an example of an operation of the image processing apparatus 1 according to the first embodiment of the present invention;

FIG. 3 is a diagram for illustrating a notable point, a corresponding point and a new point according to the first embodiment of the present invention;

FIG. 4 is a flowchart showing an example of the flow of processing of a new corresponding point C by a corresponding point increasing section 109 according to the first embodiment of the present invention;

FIG. 5 is a diagram for illustrating a corresponding point B and a new corresponding point C in the case where the center of a search range S is a pixel positioned two pixels away from a notable point, in the first embodiment of the present invention;

FIG. 6 is a diagram for illustrating an example of generating multiple new corresponding points;

FIG. 7 is a diagram for illustrating another example of generating multiple new corresponding points;

FIG. 8 is a diagram for illustrating a case where an edge passing through a notable point A and a corresponding point B is not a straight line according to a second embodiment of the present invention;

FIG. 9 is a flowchart showing an example of the flow of processing of a new corresponding point C by the corresponding point increasing section 109 according to the second embodiment of the present invention;

FIG. 10 is a flowchart showing an example of the flow of processing of a new corresponding point C by the corresponding point increasing section 109 according to a third embodiment of the present invention; and

FIG. 11 is a diagram for illustrating a position of a corresponding point B relative to a notable point A in the case of generating a new corresponding point C according to the third embodiment of the present invention.

### DETAILED DESCRIPTION OF THE INVENTION

Embodiments of the present invention will be described below with reference to drawings.

### First Embodiment

### Configuration

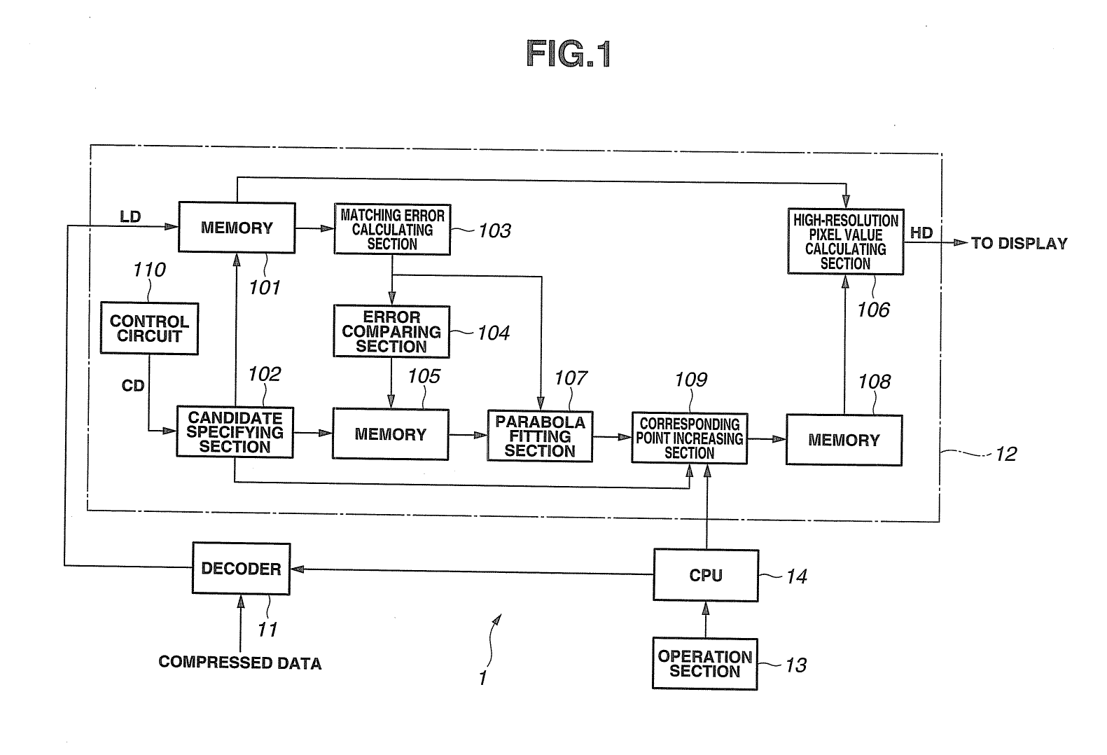

First, a configuration of an image processing apparatus according to a first embodiment of the present invention will be described on the basis of FIG. 1. FIG. 1 is a configuration diagram showing the configuration of the image processing apparatus 1 according to the present.

The image processing apparatus 1 is, for example, a TV set, a contents reproduction machine or the like. The image processing apparatus 1 is configured to include a decoder 11 which, by a broadcast wave from an antenna or compressed data of a motion picture or a still image included in a storage medium being inputted, decodes the broadcast wave or the compressed data, a resolution increasing section 12 which, by the image data decoded by the decoder 11 being inputted, converts the image data to high-resolution image data, and a central processing unit (hereinafter referred to as a CPU) 14 as a control section which, by an operation signal from an operation section 13, which is an operation panel or a remote controller, being inputted, controls the decoder 11 and the resolution increasing section 12.

The image data inputted via the decoder 11 has a predetermined resolution. The image processing apparatus 1 as a resolution increasing apparatus converts the resolution of the inputted image data to a predetermined higher resolution and outputs the high-resolution image data to a display. Therefore, if the image processing apparatus 1 is a TV set, a user can see the resolution-increased image on the flat panel display of the TV set.

The resolution increasing section 12 has a memory 101, a candidate specifying section 102, a matching error calculating section 103, an error comparing section 104, a memory 105, a high-resolution pixel value calculating section 106, a parabola fitting section 107, a memory 108, a corresponding point increasing section 109 and a control circuit 110. Here, each memory is a processing section for input, storage and output of predetermined data. Data storage means such as a RAM is included. If the resolution increasing section 12 is formed, for example, as one semiconductor chip, the chip constitutes a resolution increasing device.

The memory 101 is a storage section for acquiring low-resolution image data LD from the decoder 11 and storing the data. A signal indicating the position of an image part Ss for error calculation and a signal indicating the position of the pixel of a notable point A are inputted to the memory 101 from the candidate specifying section 102, and image data around the notable point A and image data of the image part Ss for error calculation are outputted to the matching error calculating section 103 from the memory 101. The memory 101 also provides the low-resolution image data LD to the high-resolution pixel value calculating section 106.

Control data CD which includes data specifying a search range S set in advance is inputted to the candidate specifying section 102 from the control circuit 110, and the candidate specifying section 102 outputs a signal indicting the position of the image part Ss for error calculation, which has been generated on the basis of the search range S, and a signal indicating the position of the notable point A to the memory 101 and the memory 105. Thus, the candidate specifying section 102 constitutes a notable pixel setting section configured to sequentially set pixels of notable points A (hereinafter, also referred to as notable pixels A) one by one from multiple pixels in one image.

The matching error calculating section 103 acquires image data around the notable pixel A and the image data of the image part Ss for error calculation from the memory 101, and calculates an error between the image data around the notable pixel A and the image data of the image part Ss for error calculation existing in the search range S which is a search area. The error is calculated, for example, by the sum of absolute differences or the sum of squared differences. The image data around the notable pixel A is, for example, data of a rectangular notable block P constituted by multiple pixels among which the notable pixel A is centered. The matching error calculating section 103 sequentially changes the position of the image part Ss for error calculation within the search range S by displacing the image part Ss by one pixel at a time along a predetermined direction, and, with the notable block P, which is the image data around the notable pixel A, and the image data of the image part Ss for error calculation as input, and the matching error calculating section 103 determines multiple errors between the two image data. The shape of the image part Ss for error calculation is the same as the shape of the notable block P which includes the notable pixel A.

The error comparing section 104 calculates magnitude relation among the multiple errors of the multiple image parts Ss which have been calculated by the matching error calculating section 103. The error comparing section 104 determines, for example, multiple positions the error of which is close to the smallest value as multiple corresponding pixel points SS1, SS2, . . . and outputs the corresponding pixel points to the memory 105. The corresponding pixel points are integer pixel points in the low-resolution image data LD.

For each of the pieces of information about the notable point A given from the candidate specifying section 102, position data of each of the corresponding pixel points SS1, SS2, . . . calculated by the error comparing section 104 is acquired from the error comparing section 104 and stored into the memory 105.

The parabola fitting section 107 performs non-integer pixel estimation using a parabola fitting method, on the basis of the position data of the multiple corresponding pixel points SS1, SS2, . . . given from the memory 105, and calculates a corresponding points B for the notable pixel A.

In the non-integer pixel estimation for calculation of the corresponding points B, a method other than the parabola fitting method, for example, an isometric fitting method or an over sampling method may be used.

The matching error calculating section 103, the error comparing section 104 and the parabola fitting section 107 constitute a corresponding point extracting section configured to extract a corresponding point B corresponding to the pixel of the notable point A from a corresponding block Q having a pixel value change pattern identical or similar to the pixel value (that is, brightness values) change pattern included in the notable block P which includes the pixel of the notable point A.

The corresponding point increasing section 109 acquires position data of a corresponding point B from the parabola fitting section 107, and position data of the notable block P from the candidate specifying section 102.

As described later, the corresponding point increasing section 109 sets an intermediate position between the notable point A and the corresponding point B as the position of a new corresponding point C, and inputs position data of both of the new corresponding point C and the originally acquired corresponding point B to the memory 108. This means that, on the assumption that the notable point A of the notable block P and the acquired corresponding point B exist on a straight-line edge of the same subject, the intermediate point between the notable point A and the corresponding point B is added as a new corresponding point. A method for calculating the position of the new corresponding point will be described later. The corresponding point increasing section 109 constitutes a new corresponding point generating section configured to generate a new corresponding point within an interval of a line segment obtained by rectilinearly connecting the notable point A and the corresponding point B.

The memory 108 stores the position information about the corresponding points B and C determined by the corresponding point increasing section 109.

The control circuit 110 generates and outputs control data CD for specifying the notable points A in a predetermined order from the low-resolution image data LD. For example, the control circuit 110 outputs control data CD sequentially specifying the notable points A from the top left in a horizontal direction as well as in a vertical direction. Furthermore, the control data CD also includes a control signal specifying a search range S corresponding to the notable point A.

As a result, the corresponding point increasing section 109 stores data of the corresponding points B and C into the memory 108 for each notable point of the low-resolution image data LD.

The high-resolution pixel value calculating section 106 acquires each pixel data of the low-resolution image data LD from the memory 101 and position data of the corresponding points B and C for each notable point A from the memory 108, and obtains pixel values of the corresponding points B and C on the assumption that the same pixel value as that of the corresponding point A exists at the positions of the corresponding points B and C. For example, by solving predetermined conditional expressions as a set of simultaneous equations using each pixel data of the low-resolution image and position data of each corresponding point, the high-resolution pixel value calculating section 106 determines the pixel value of a sample point of high-resolution image data and outputs the pixel value data. More specifically, by assuming a pixel value of the high-resolution image to be an unknown, setting a conditional expression indicating that a temporary sample value calculated from the unknown equals to the sample value of the brightness value at a corresponding point, for each sample value, and solving multiple such conditional expressions as a set of simultaneous equations, the pixel value of the high-resolution image is calculated. As described above, the high-resolution pixel value calculating section 106 calculates a pixel value of the high-resolution image from the notable point A, the corresponding point B and the new corresponding point C.

### (Operation)

Next, the operation of the image processing apparatus 1 described above will be described in more detail.

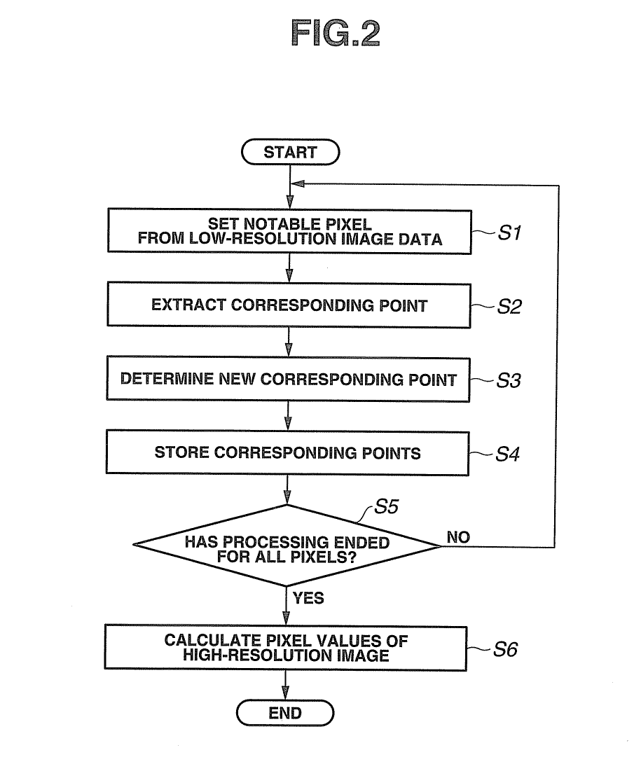

FIG. 2 is a flowchart for illustrating an example of the operation of the image processing apparatus 1. First, the candidate specifying section 102 constituting the notable pixel setting section sets the position of pixels of notable points A (that is, notable pixels) from low-resolution image data LD on the basis of control data CD from the control circuit 110 in a predetermined order (step S1). As the order, for example, so-called raster order from the top-left pixel on the screen of one frame of a motion picture or a still image toward the right, and from the top line toward the bottom line can be used.

Next, the matching error calculating section 103, the error comparing section 104 and the parabola fitting section 107 constituting the corresponding point extracting section extract the position of the corresponding point B by comparing a pixel value change pattern in an area Ss with the same shape as a notable block P which has been set by moving within a predetermined search range S in an image and a pixel value change pattern included in the notable block P (step S2). Specifically, extraction of the position of the corresponding point B is performed by calculating the position of the corresponding point B by non-integer pixel estimation by the parabola fitting method or the like, on the basis of pixel value data of each of set multiple areas Ss with the same shape.

The corresponding point increasing section 109 constituting a new corresponding point generating section calculates and determines the position of a new corresponding point C from the notable point A and the corresponding point B (step S3) and stores the corresponding point B and the calculated new corresponding point C into the memory 108 as corresponding point position information (step S4). Calculation of the position of the new corresponding point C by the corresponding point increasing section 109 will be described later.

Next, it is judged whether or not processing has ended for all pixels set as notable points of the low-resolution image data LD (step S5).

If the processing has not ended for all the pixels that can be a notable point, the judgment is NO at step S5, and the processing returns to step S1. At step S1, a next pixel determined in predetermined order is set as a notable pixel.

If the processing has ended for all the pixels that can be a notable point, the judgment is YES at step S5. Assuming that the high-resolution pixel value calculating section 106 assumes that the same pixel value as that of the corresponding point A exists at the positions of the corresponding points B and C, the high-resolution pixel value calculating section 106 calculates each pixel value of a high-resolution image using all the pixels of the low-resolution image data LD and position data of pixels of all the corresponding points stored in the memory 108 (step S6) and outputs high-resolution image data HD.

The high-resolution pixel value calculating section 106 calculates pixel values of the high-resolution image data HD using a nonuniform interpolation method as disclosed in Japanese Patent Application Laid-Open Publication No. 2007-310837, a POCS method or the like. That is, the number of samples of a low-resolution image, which is a known value, is added to a set of pixel values of the high-resolution image having unknown values. Then, by using the nonuniform interpolation method or the POCS method which is a method of determining the values of pixels of a high-resolution image which are uniformly arranged in a grid-like fashion, from the multiple sample values arranged uniformly, a high-resolution image can be calculated.

Next, the notable point and the corresponding point in the above processing will be described. First, a method for calculating a new corresponding point at step S3 will be described.

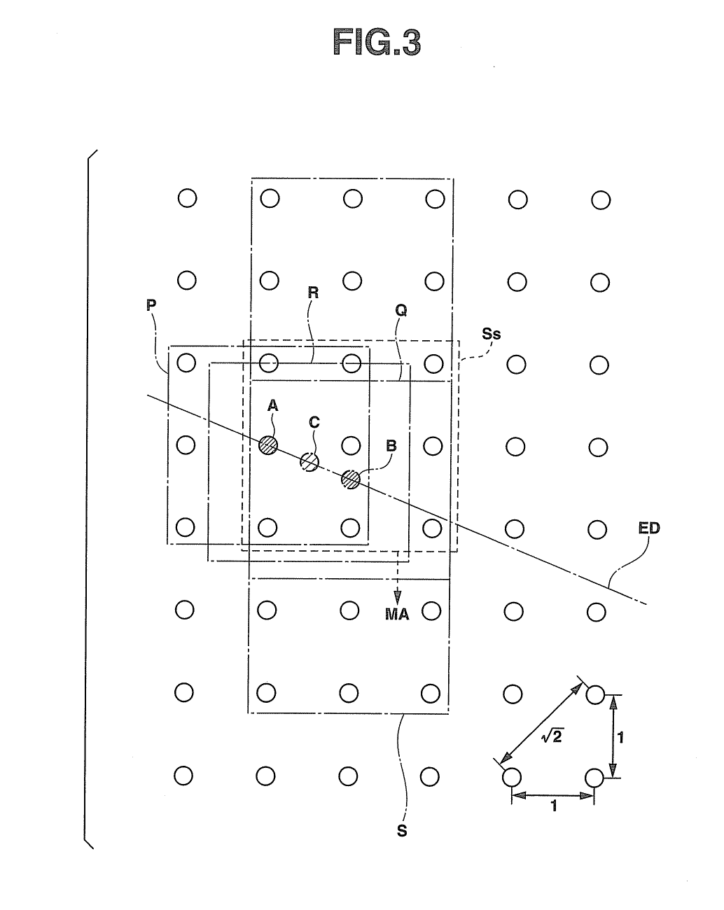

FIG. 3 is a diagram for illustrating a notable point, a corresponding point and a new corresponding point. In FIG. 3, each of multiple white circles uniformly arranged in a grid-like fashion indicates a pixel in a low-resolution image. The pixel of a notable point A (a notable pixel) indicated by a shaded circle is specified by control data CD from the control circuit 110, for example, in raster order as described above. A notable block P including the notable pixel A, a search range S and an image part Ss for error calculation in the search range S are also specified by the control data CD. Here, the search range S is a rectangular area which vertically includes multiple pixels including a point adjacent to the notable point A.

In FIG. 3, the notable point A is a point centered in the notable block P constituted by 3×3 pixels. As described above, from the pixel value change pattern of multiple pixels included in the notable block P and the pixel value change pattern of each of multiple pixel parts Ss included in the search range S, multiple positions the error of which is close to the smallest value are determined as multiple corresponding pixel points by the matching error calculating section 103 and the error comparing section 104. In this case, by moving the image parts Ss included in the search range S from the top of the search range S toward a predetermined direction (the vertical direction of the image indicated by an arrow MA in FIG. 3), the multiple corresponding pixel points are determined. The corresponding points B are points calculated and determined by the parabola fitting section 107 on the basis of the determined multiple corresponding pixel points.

The image part Ss is an area included in the search range S, and its shape is the same as that of the notable block P. In FIG. 3, however, the image part Ss is shown a little larger in order to clearly indicate its position.

The search range S, which is a search area, is a vertically extending m×n (m and n are integers) pixel area, with a pixel horizontally adjacent to the notable point A as the center and with a predetermined width. In FIG. 3, the search range S is a 7×3 pixel area. The search range S includes a pixel adjacent to the notable point A, and an area Ss with the same shape and with the adjacent pixel as the center is set within the search range S. Such areas Ss are sequentially set within the search range S in a manner that they are displaced from an immediately previously set area Ss by one pixel in the vertical direction of the image.

Here, the search range S, which is a search area, is set as an area extending in the vertical direction of the image, and the notable points A are sequentially set by moving from pixel to pixel along the vertical direction of the image. However, the search range S may be set as an area extending in the horizontal direction of the image, and the notable points A may be sequentially set by moving from pixel to pixel along the horizontal direction of the image.

The corresponding point B is a point in a corresponding area (hereinafter, also referred to as a corresponding block) Q which has a change pattern the most similar to the pixel value change pattern included in the notable block P for the notable point A, within the search range S. In the case of FIG. 3, since the notable point A is the central point in the notable point block P, the corresponding point B is positioned at the center of the corresponding area Q.

If it is assumed that the notable point A of the notable block P and the acquired corresponding point B exist on a straight-line edge ED of a same subject, it can be presumed that a line connecting the notable point A and the corresponding point B also exists on the straight-line edge ED. In the present, a new corresponding point C is generated on the middle point of the line connecting the notable point A and the corresponding point B, that is, a point which divides the interval of a line segment obtained by rectilinearly connecting the notable point A and the corresponding point B. In this case, it can be presumed that a 3×3 area block R which includes the new corresponding point C also has the same pixel value change pattern as that of the corresponding point Q which includes the corresponding point B.

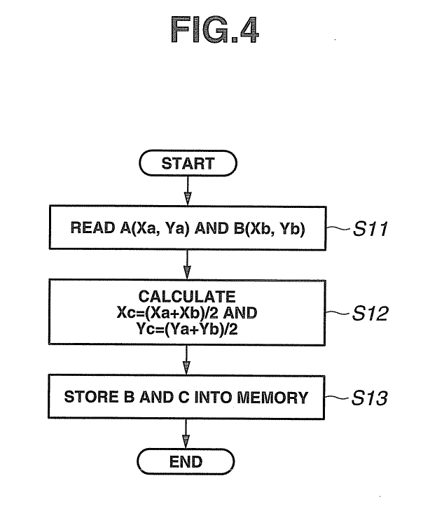

The contents of the processing by the corresponding point increasing section 109 described above will be described with the use of FIG. 4. FIG. 4 is a flowchart showing an example of the flow of processing of a new corresponding point C by the corresponding point increasing section 109. First, a position (Xa, Ya) of a notable point A and a position (Xb, Yb) of a corresponding point B on the screen are read (step S11).

The corresponding point increasing section 109 calculates a position (Xc, Yc) of a new corresponding point C using the following equations (step S12):

Xc=(Xa+Xb)/2 (1)

Yc=(Ya+Yb)/2 (2)

The corresponding point increasing section 109 stores position data of the corresponding point B and the new corresponding point C obtained by calculation into the memory 108 (step S13).

As described above, for one notable point A, two corresponding points B and C are calculated and obtained by searching one search range S once. That is, by searching the search range S once using calculation such as calculation of the sum of squared differences, for one notable point A, not one corresponding point B but two corresponding points B and C can be calculated by the one search. In other words, it is possible, in the case of searching the search range S for a corresponding block having the same brightness value change pattern as that of a notable block P, which is a local area constituted by multiple pixel values on a digital image, to increase the number of corresponding points while suppressing increase in the amount of calculation.

If the position of a calculated corresponding point is near an integer-pixel precision position in the low-resolution image, a problem is caused that there is no contribution to generation of a clear high-resolution image. However, in the case of FIG. 3, since the corresponding point B is positioned on a vertical line which includes a pixel adjacent to the notable point A, the position of the pixel of the obtained new corresponding point C does not overlap with a pixel position (a sample point) in the original low-resolution image. Thus, the high-resolution pixel value calculating section 106 can generate a clear high-resolution image.

In the example described above, the search range S is an area with a predetermined width and with a pixel adjacent to the notable point A as the center. However, the search range S may be an area with a predetermined width and with a pixel positioned two or more pixels away from the notable point A as the center.

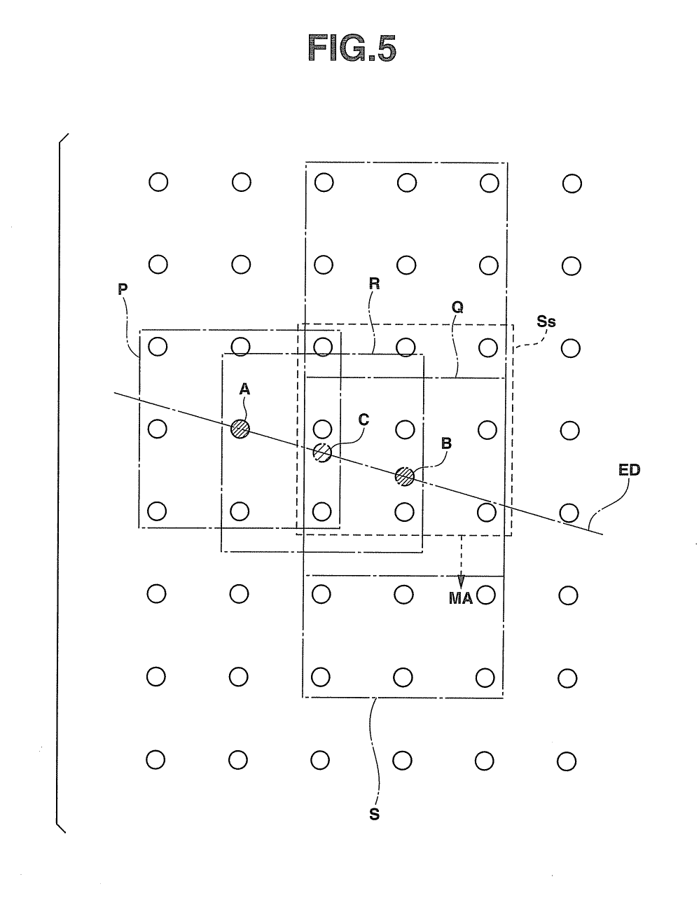

FIG. 5 is a diagram for illustrating a corresponding point B and a new corresponding point C in the case where the center of a search range S is a pixel positioned two pixels away from a notable point A. Reference numerals in FIG. 5 are the same as those in FIG. 3. As shown in FIG. 5, the new corresponding point C calculated from the notable point A and the corresponding point B is positioned on a pixel column adjacent to the notable point A.

Furthermore, though one new corresponding point C is generated from the notable point A and the corresponding point B in the example described above, two or more new corresponding points C may be generated.

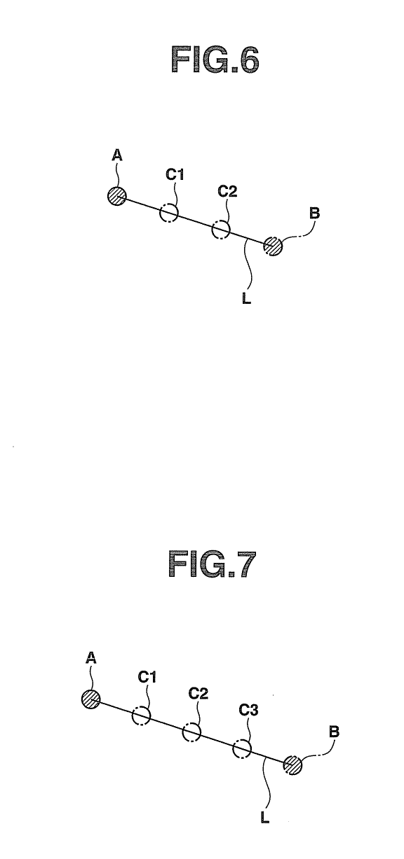

FIGS. 6 and 7 are diagrams for illustrating an example of generating multiple new corresponding points. The corresponding point increasing section 109 may calculate two points C1 and C2 obtained when a line segment L connecting the notable point A and the corresponding point B described with reference to FIG. 3 or FIG. 5 is divided into three equal parts as shown in FIG. 6, or the line segment L may be divided into four equal parts to generate three corresponding points as shown in FIG. 7. Thus, the corresponding point increasing section 109 may divide the line segment L connecting the notable point A and the corresponding point B into equal parts to generate two or more new corresponding points.

As described above, according to the image processing apparatus having the resolution increasing section according to the present, it is possible to increase the number of corresponding points without increasing the number of corresponding points by enlarging a search range S as has been conventionally done. Therefore, it is possible to improve the image quality of an image enlarged by resolution increasing processing while suppressing increase in the amount of calculation.

### Second Embodiment

In the first embodiment, attention is not especially paid to the distance between the notable point A and the corresponding point B, and it is assumed that the assumed edge is a straight line. However, if the edge is not a straight line, the image quality of a generated high-resolution image deteriorates. Therefore, in this second embodiment, in order to prevent image deterioration due to such a cause, addition of a new corresponding point described in the first embodiment is not performed if the distance between the notable point A and the corresponding point B exceeds a predetermined distance.

An image processing apparatus according to the present is configured similarly to the image processing apparatus 1 described in the first embodiment, and it is only the contents of processing by the corresponding point increasing section 109 that is different from the first embodiment. Therefore, for the image processing apparatus according to the second embodiment, the same reference numerals will be used for the same components as those in the first embodiment, and description of the components will be omitted. Description will be made mainly on different items.

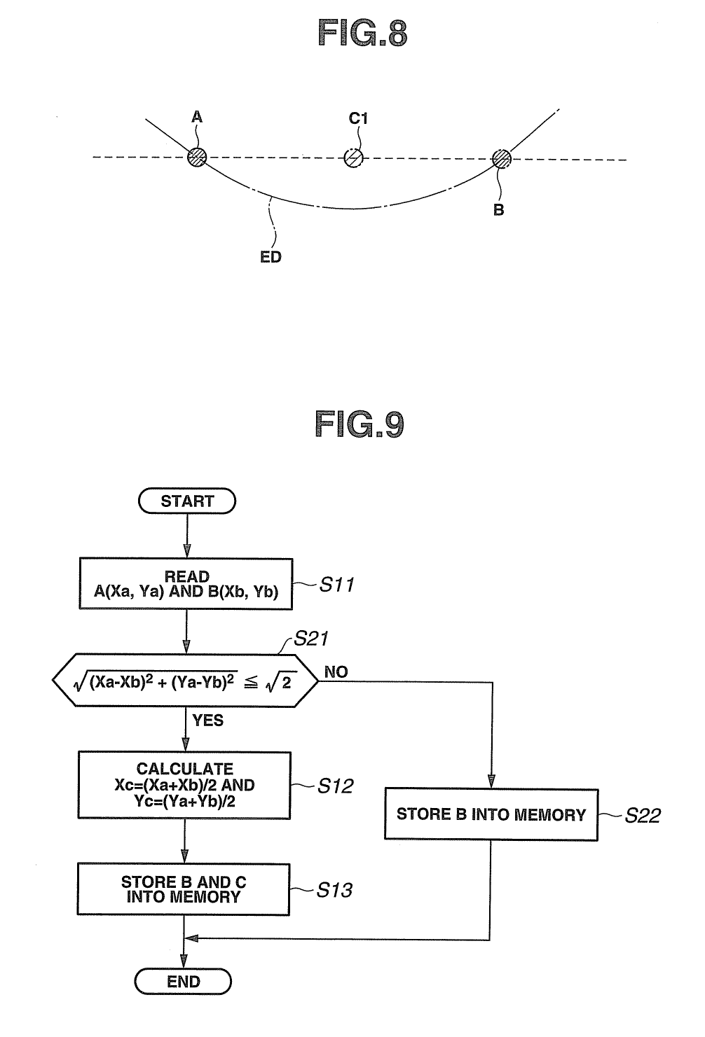

FIG. 8 is a diagram for illustrating a case where an edge passing through a notable point A and a corresponding point B is not a straight line. Since it is assumed in the first embodiment that the notable point A and the corresponding point B are on a straight-line edge, a generated new corresponding point C (or multiple new corresponding points C) is generated on a line segment indicated by a broken line connecting the notable point A and the corresponding point B as shown in FIG. 8. However, if an edge ED in an actual image is a curved line indicated by an alternate long and short dash line, that is, if the above assumption is not satisfied, then the image quality of a generated high-resolution image may deteriorate when the high-resolution image is generated with the use of the generated new corresponding point C.

Therefore, in the present, a new corresponding point C is added only when the distance between the notable point A and the corresponding point B is within a predetermined distance.

Here, a predetermined distance T is “2^{(1/2)}” when it is assumed that the distance between two adjacent pixels among the pixels arranged in a grid-like fashion in a low-resolution image (that is, the distance between two adjacent pixels in a vertical or horizontal direction of the image) is “1” (see FIG. 3). If the distance between the notable point A and the corresponding point B is within the predetermined distance T (=2^{(1/2)}), a new corresponding point C is generated and added. If the distance exceeds the predetermined distance, addition of a new corresponding point C is not performed.

As shown in FIG. 3, “2^{(1/2)}” (that is, the square root of 2) means the distance between the notable point A and four pixels existing in directions 45 degrees obliquely from the notable point A. In other words, “2^{(1/2)}” is the distance between the notable point A and the nearest pixel existing in a diagonal direction from the notable point A. The predetermined distance T (=2^{(1/2)}) is such a short distance. If the distance between the notable point A and the corresponding point B is equal to or shorter than the short distance, a virtual edge between the two points A and B can be regarded as an almost straight line. Therefore, if the distance between the notable point A and the corresponding point B is equal to or shorter than the predetermined distance T (=2^{(1/2)}), a new corresponding point C is added.

FIG. 9 is a flowchart showing an example of the flow of processing of a new corresponding point C by the corresponding point increasing section 109 according to the present. The flowchart of FIG. 9 is different from the flowchart of FIG. 4 in that it includes step S21. Other processings are similar to those in FIG. 4.

As shown in FIG. 9, after a notable point A and a corresponding point B are read at step S11, it is judged whether the distance between the notable point A and the corresponding point B is within a predetermined distance T (step S21).

If the distance between the notable point A and the corresponding point B is within the predetermined distance T, the judgment is YES at S21. The processing proceeds to step S12, and the corresponding point B and a new corresponding point C are stored into the memory 108 (step S13). However, if the distance between the notable point A and the corresponding point B exceeds the predetermined distance T, the judgment is NO at S21. The processing proceeds to step S22, and the corresponding point B is stored into the memory 108.

As described above, according to the present, the following advantage is also obtained in addition to the advantage of the first embodiment. That is, even when the notable point A and the corresponding point B are not actually on a straight-line edge, the edge of that part can be locally regarded as a straight line if the distance is within a predetermined distance, and, therefore, deterioration of the image quality of a high-resolution image does not occur. That is, according to the present, it is possible to increase the number of corresponding points without searching for corresponding points and improve the image quality of an image enlarged by resolution increasing processing while suppressing increase in the amount of calculation and suppressing image quality deterioration due to increase in the number of inappropriate corresponding points.

Furthermore, since processing for increasing the number of corresponding points is performed only when the distance between the two points is within a predetermined distance, the assumption that the notable point A and the corresponding point B should be on a same straight-line edge is always satisfied, and it is possible to suppress image deterioration of a high-resolution image which occurs when the assumption is not satisfied.

### Third Embodiment

In the two embodiments described above, the high-resolution pixel value calculating section 106 calculates and generates high-resolution image data HD from obtained corresponding points (including new corresponding points) and pixel data of low-resolution image data LD. However, there may be a case where it is not desirable from the viewpoint of the performance of the high-resolution pixel value calculating section 106 that the high-resolution pixel value calculating section 106 performs processing, such as solving predetermined conditional expressions as a set of simultaneous equations, including all the obtained new corresponding points.

Therefore, in the present, the corresponding point increasing section 109 increases only the number of such corresponding points that significantly contribute to improvement of image quality and does not increase the number of corresponding points without consideration in order to suppress the amount of calculation by the high-resolution pixel value calculating section 106.

An image processing apparatus according to the present is configured similarly to the image processing apparatus 1 described in the first and second embodiments, and it is only the contents of the processing by the corresponding point increasing section 109 that is different from the first and second embodiments. Therefore, for the image processing apparatus according to the third embodiment, the same reference numerals will be used for the same components as those in the first and second embodiments, and description of the components will be omitted. Description will be made mainly on different items.

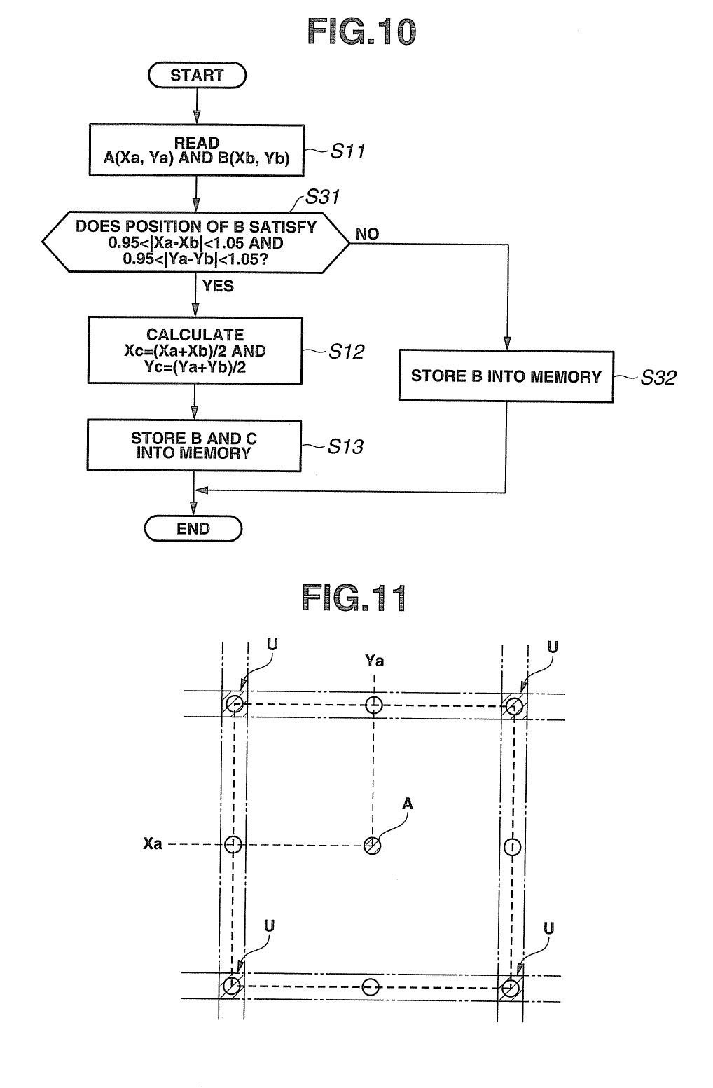

FIG. 10 is a flowchart showing an example of the flow of processing of a new corresponding point C by the corresponding point increasing section 109 according to the present. The flowchart of FIG. 10 is different from the flowchart of FIG. 4 in that it includes step S31. Other processings are similar to those in FIG. 4.

As shown in FIG. 10, after a notable point A and a corresponding point B are read at step S11, it is judged whether the corresponding point B is within a predetermined range U relative to the notable point A (step S31).

As described above, the corresponding point increasing section 109 acquires the position of the corresponding point B from the parabola fitting section 107, and the position of the notable point A from the candidate specifying section 102. Here, positions indicating the notable point A, which is the center of a notable block P, and the corresponding point B, which is the center of a corresponding point block Q, are denoted by (xa, ya) and (xb, yb), respectively. Only when both of the two expressions below are satisfied, the position of the intermediate point between the notable point A and the corresponding point B is set as a corresponding point C. Both of the new corresponding point C and the originally acquired corresponding point are inputted to the memory 108.

Specific description will be made with the use of FIG. 11. FIG. 11 is a diagram for illustrating the position of a corresponding point B relative to a notable point A in the case of generating a new corresponding point C. It is assumed that the position of the notable point A on an image is (xa, ya) with the top left of the image as a point of reference, and the position of the corresponding point B on the image is (xb, yb) similarly. In other words, xa and xb indicate the distances between the points and the left end of the image, respectively, and ya and yb indicate the distances between the points and the upper end of the image, respectively. The distance between adjacent pixels among low-resolution pixels arranged in a grid-like fashion is assumed to be 1. In this case, only when the corresponding point B exists in a range which satisfies the following two expressions, the corresponding point increasing section 109 stores the positions of the corresponding points B and C into the memory 108.

0.95<|Xa−Xb|<1.05 (3)

0.95<|Ya−Yb|<1.05 (4)

If the corresponding point B is within the range U which satisfies the above two expressions (3) and (4), the processing proceeds to step S12, and the corresponding point B and the new corresponding point C are stored into the memory 108 (step S13). However, if the corresponding point B is not within the range U which satisfies the above two expressions (3) and (4), the processing proceeds to step S32, and the corresponding point B is stored into the memory 108.

The range U defined by the above expressions (3) and (4) is a range as shown in FIG. 11. The case where the corresponding point B is within the range U is the case where the corresponding point B exists in a direction about 45 degrees obliquely from the notable point A. If a new corresponding point C is generated when the corresponding point B exists within such a range, the resolution increasing effect easily appears when an edge exists. That is, significant contribution to improvement of image quality is made.

It is also possible to erase the original corresponding point B acquired from the parabola fitting section 107 because it does not contribute to increase in the number of sample points, and input only the new corresponding point C to the memory 108 at step S13. Thereby, it is possible to further reduce the amount of calculation by the subsequent-stage high-resolution pixel value calculating section 106.

Furthermore, though the values “0.95” and “1.05” in the above expressions (3) and (4) are the best values the applicant obtained from experiments and the like, other values may be used instead of “0.95” and “1.05”.

Thus, according to the present, since a new corresponding point C is added only for a corresponding point B from which significant contribution to improvement of image quality is expected, it is possible to efficiently improve the image quality of an image enlarged by resolution increasing processing while suppressing the amount of calculation by the subsequent-stage high-resolution pixel value calculating section 106.

As described above, according to the image processing apparatus according to each embodiment described above, it is possible to increase the number of corresponding points without increasing the number of corresponding points by enlarging the search range S as has been conventionally done. Therefore, it is possible to improve the image quality of an image enlarged by resolution increasing processing while suppressing increase in the amount of calculation.

Furthermore, a method obtained by combining the second and third embodiments described above may be adopted. That is, a new corresponding point C may be added only when the distance between the notable point A and the corresponding point B is within a predetermined distance as described in the second embodiment and, simultaneously, the corresponding point B is within a predetermined range as described in the third embodiment. Thereby, it is possible to obtain a high-resolution image with a higher image quality while suppressing the amount of calculation.

Furthermore, the following is also possible. That is, the image processing apparatus is adapted to execute any of operation modes according to the first embodiment system, the second embodiment system and the third embodiment system described above, and any of the operation modes is selected and executed according to the operation mode set by a user on the operation section 13 or the operation mode set in advance for an image to be inputted.

For example, the image processing apparatus 1 is configured so that an operation mode for the corresponding point increasing section 109, that is, any of the operation modes of the systems according to the first, second and third embodiments can be selected by the user giving an operation instruction to the operation section 13. Thereby, when the image processing apparatus operates with a battery and the user wants to view an image with as little power consumption as possible, he can select the system of the third embodiment. In the case of ordinary contents, the user can select the system of the second embodiment. In the case of contents which the user wants to appreciate with a high image quality, he can select the system of the first embodiment.

In addition, the three systems may be automatically selected according to what is included in the image contents or according to the length of the contents. For example, in the case of such contents that the image quality does not matter or in the case of long contents, the system of the third embodiment may be selected. In the case of contents to be appreciated with a high image quality, the form of the first embodiment may be selected.

If data for the selection, for example, data such as genre information and reproduction time is included in contents themselves, the image processing apparatus 1 can select one system from among the three systems on the basis of the data.

Each “section” in this specification conceptually corresponds to each function of the embodiments, and it does not necessarily correspond to one particular hardware or software routine. Therefore, in this specification, the embodiments have been described on the assumption of virtual circuit blocks (sections) having the functions of the embodiments, respectively. Furthermore, as for the steps of each procedure in each embodiment, the execution order may be changed, multiple steps may be executed simultaneously, or the steps may be executed in different order each time, as far as it does not go against the nature of the steps.

As for a program for executing the operation described above, the whole or a part of the program code is recorded or stored in a portable medium such as a flexible disk and a CD-ROM or a storage medium such as a hard disk as a computer program product. The program is read by a computer, and all or a part of the operation is executed. Instead, the whole or a part of the code of the program may be distributed or provided via a communication network. A user can easily realize the resolution increasing apparatus of the present invention by downloading the program via a network and installing it into a computer or by installing it from a recording medium.

As described above, according to each embodiment described above, it is possible to realize a resolution increasing apparatus capable of increasing the number of corresponding points and performing resolution increasing processing while suppressing accumulative increase in the amount of calculation, a method therefor, and, furthermore, a recording medium therefor.

The present invention is not limited to the embodiments described above, and various changes and modifications can be made within the range not departing from the spirit of the present invention.

What is claimed is:

1. A resolution increasing apparatus comprising:
a notable pixel setting section configured to sequentially set pixels of notable points one by one from multiple pixels in one image;
a corresponding point extracting section configured to extract a corresponding point corresponding to a pixel of the notable point from a corresponding block having a pixel value change pattern identical or similar to a pixel value change pattern included in a notable block that includes the pixel of the notable point;
a new corresponding point generating section configured to generate a new corresponding point within an interval of a line segment obtained by rectilinearly connecting the notable point and the corresponding point; and
a high-resolution pixel value calculating section configured to calculate a pixel value of a high-resolution image from the notable point, the corresponding point and the new corresponding point.

2. The resolution increasing apparatus according to claim 1, wherein
the corresponding point extracting section extracts the corresponding point by comparing a pixel value change pattern in an area with the same shape as the notable block that has been set by moving within a predetermined search area in the image and a pixel value change pattern included in the notable block.

3. The resolution increasing apparatus according to claim 2, wherein the corresponding point extracting section extracts the corresponding point by calculating a position of the corresponding point by non-integer pixel estimation on the basis of pixel value data of each of set multiple areas with the same shape.

4. The resolution increasing apparatus according to claim 3, wherein the predetermined search area includes pixels adjacent to the pixel of the notable point, and the areas with the same shape and with the adjacent pixels as the centers are set within the predetermined search area in a manner that the areas are displaced by one pixel at a time.

5. The resolution increasing apparatus according to claim 4, wherein the one-pixel displacement is displacement along a vertical or horizontal direction of the image.

6. The resolution increasing apparatus according to claim 1, wherein the new corresponding point is set at a position of a point that divides the interval of the line segment into equal parts.

7. The resolution increasing apparatus according to claim 6, wherein the point that divides the interval of the line segment into equal parts is a point that divides the interval of the line segment into two equal parts.

8. The resolution increasing apparatus according to claim 1, wherein, if the length of a line segment obtained by rectilinearly connecting the notable point and the corresponding point is equal to or less than a distance of a square root of 2 when a distance between pixels in a vertical or horizontal direction of the image is assumed to be 1, the new corresponding point generating section generates the new corresponding point.

9. The resolution increasing apparatus according to claim 1, wherein, if the corresponding point satisfies both of 0.95<|Xa−Xb|<1.05 and 0.95<|Ya−Yb|<1.05 for the notable point when a position of the notable point on the image is assumed to be (Xa, Ya) and a position of the corresponding point is assumed to be (Xb, Yb), the new corresponding point generating section generates the new corresponding point.

10. A resolution increasing apparatus comprising:
a notable pixel setting section configured to sequentially set pixels of notable points one by one from multiple pixels in one image;
a corresponding point extracting section configured to extract a corresponding point corresponding to a pixel of the notable point from a corresponding block having a pixel value change pattern identical or similar to a pixel value change pattern included in a notable block that includes the pixel of the notable point;
a new corresponding point generating section configured to generate a new corresponding point within an interval of a line segment obtained by rectilinearly connecting the notable point and the corresponding point; and
a high-resolution pixel value calculating section configured to calculate a pixel value of a high-resolution image from the notable point, the corresponding point and the new corresponding point; wherein
the new corresponding point generating section is capable of selecting any of the following:
to generate the new corresponding point if, when a distance between pixels in a vertical or horizontal direction of the image is assumed to be 1, the length of a line segment obtained by rectilinearly connecting the notable point and the corresponding point is equal to or less than the distance of a square root of 2; and
to generate the new corresponding point if, when a position of the notable point on the image is assumed to be (Xa, Ya) and a position of the corresponding point is assumed to be (Xb, Yb), both of 0.95<|Xa−Xb|<1.05 and 0.95<|Ya−Yb|<1.05 are satisfied.

11. The resolution increasing apparatus according to claim 10, wherein the selection is performed in accordance with setting of an operation mode for the new corresponding point generating section.

12. The resolution increasing apparatus according to claim 11, wherein the operation mode is set for the image in advance or set by a user.

13. A resolution increasing method for increasing resolution of one image, the method having a notable point pixel setting section, a corresponding point extracting section and a high-resolution pixel value calculating section, comprising:
sequentially setting pixels of notable points one by one from multiple pixels in the image by the notable pixel setting section;
extracting a corresponding point corresponding to a pixel of the notable point from a corresponding block having a pixel value change pattern identical or similar to a pixel value change pattern included in a notable block that includes the pixel of the notable point, by the corresponding point extracting section;
generating a new corresponding point within an interval of a line segment obtained by rectilinearly connecting the notable point and the corresponding point; and
calculating a pixel value of a high-resolution image from the notable point, the corresponding point and the new corresponding point by the high-resolution pixel value calculating section.

14. The resolution increasing method according to claim 13, wherein
the corresponding point extracting section extracts the corresponding point by comparing a pixel value change pattern in an area with the same shape as the notable block that has been set by moving within a predetermined search area in the image and a pixel value change pattern included in the notable block.

15. The resolution increasing method according to claim 14, wherein the corresponding point extracting section extracts the corresponding point by calculating a position of the corresponding point by non-integer pixel estimation on the basis of pixel value data of each of set multiple areas with the same shape.

16. The resolution increasing method according to claim 15, wherein
the predetermined search area includes pixels adjacent to the pixel of the notable point, and the areas with the same shape and with the adjacent pixels as the centers are set within the predetermined search area in a manner that the areas are displaced by one pixel at a time.

17. The resolution increasing method according to claim 16, wherein the one-pixel displacement is displacement along a vertical or horizontal direction of the image.

18. The resolution increasing method according to claim 13, wherein, if the length of a line segment obtained by rectilinearly connecting the notable point and the corresponding point is equal to or less than the distance of a square root of 2 when a distance between pixels in a vertical or horizontal direction of the image is assumed to be 1, the new corresponding point is generated.

19. The resolution increasing method according to claim 13, wherein, if the corresponding point satisfies both of 0.95<|Xa−Xb|<1.05 and 0.95<|Ya−Yb|<1.05 when a position of the notable point on the image is assumed to be (Xa, Ya) and a position of the corresponding point is assumed to be (Xb, Yb), the new corresponding point is generated.
